(19) United States
(12) Patent Application Publication
(10) Pub. No.: US 2026/0095295 A1
(43) Pub. Date: Apr. 2, 2026

(54) QUASI-CO-LOCATION ASSUMPTIONS FOR NEAR-FIELD AND FAR-FIELD COMMUNICATION

(71) Applicant: Apple Inc., Cupertino, CA (US)

(72) Inventors: Ankit Bhamri, Haar (DE); Dawei Zhang, Saratoga, CA (US); Haitong Sun, Saratoga, CA (US); Wei Zeng, Saratoga, CA (US); Weidong Yang, San Diego, CA (US)

(73) Assignee: Apple Inc., Cupertino, CA (US)

(21) Appl. No.: 19/312,093

(22) Filed: Aug. 27, 2025

Related U.S. Application Data
(60) Provisional application No. 63/700,507, filed on Sep. 27, 2024.

(51) Int. Cl. H04L 5/00; H04W 4/80; H04W 72/044

(52) U.S. Cl. CPC H04L 5/0094; H04W 4/80; H04W 72/046

(57) ABSTRACT

The present application relates to devices and components including apparatus, systems, and methods to configure and implement quasi-co-location assumptions in wireless communication systems.

### CROSS-REFERENCES TO RELATED APPLICATIONS

This application claims the benefit to U.S. Provisional Application No. 63/700,507, filed Sep. 27, 2024, entitled “Quasi-Co-Location Assumptions for Near-Field and Far-Field Communication,” the disclosure which is incorporated by reference in its entirety and for all purposes.

### TECHNICAL FIELD

The present application relates to the field of wireless technologies and, in particular, to quasi-co-location assumptions for near-field and far-field communication.

### BACKGROUND

Third Generation Partnership Project (3GPP) networks have developed to implement beamforming for communication between network elements. For example, a base station may generate a beam to transmit a signal to a user equipment (UE). The beamforming can allow for signals to be directed in a particular direction toward a particular network element rather than the signal being broadcast in all directions. This beamforming can improve the operation of the networks.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates a table of example near-field range determinations in accordance with some embodiments.

FIG. 5 illustrates an example beamforming arrangement in accordance with some embodiments.

FIG. 6 illustrates representations of example normalized array gains in the physical space in accordance with some embodiments.

FIG. 7 illustrates a table of parameters for an example simulation scenario in accordance with some embodiments.

FIG. 8 illustrates an example arrangement for the example simulation scenario in accordance with some embodiments.

FIG. 9 illustrates an example normalized beamforming gain representation for carrier frequency of 7 gigahertz (GHz) in accordance with some embodiments.

FIG. 10 illustrates an example normalized beamforming gain representation for carrier frequency of 15 GHz in accordance with some embodiments.

FIG. 11 illustrates an example normalized beamforming gain per subcarrier index representation for carrier frequency of 7 GHz and bandwidth (BW) size of 100 megahertz (MHz) in accordance with some embodiments.

FIG. 12 illustrates an example normalized beamforming gain per subcarrier index representation for carrier frequency of 15 GHz and BW size of 100 MHz in accordance with some embodiments.

FIG. 13 illustrates an example normalized beamforming gain per subcarrier index representation for carrier frequency of 7 GHz and bandwidth size of 400 MHz in accordance with some embodiments.

FIG. 14 illustrates an example table of transmission configuration indicator (TCI) information in accordance with some embodiments.

FIG. 15 illustrates an example table of TCI information in accordance with some embodiments.

FIG. 16 illustrates an example table of TCI information in accordance with some embodiments.

FIG. 17 illustrates an example table of TCI information in accordance with some embodiments.

FIG. 18 illustrates an example table of TCI information in accordance with some embodiments.

FIG. 19 illustrates an example procedure for processing a reference signal (RS) with a spatial filter in accordance with some embodiments.

FIG. 20 illustrates an example procedure for processing an RS in accordance with an indicated field assumption in accordance with some embodiments.

FIG. 21 illustrates an example procedure for generating a TCI configuration in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

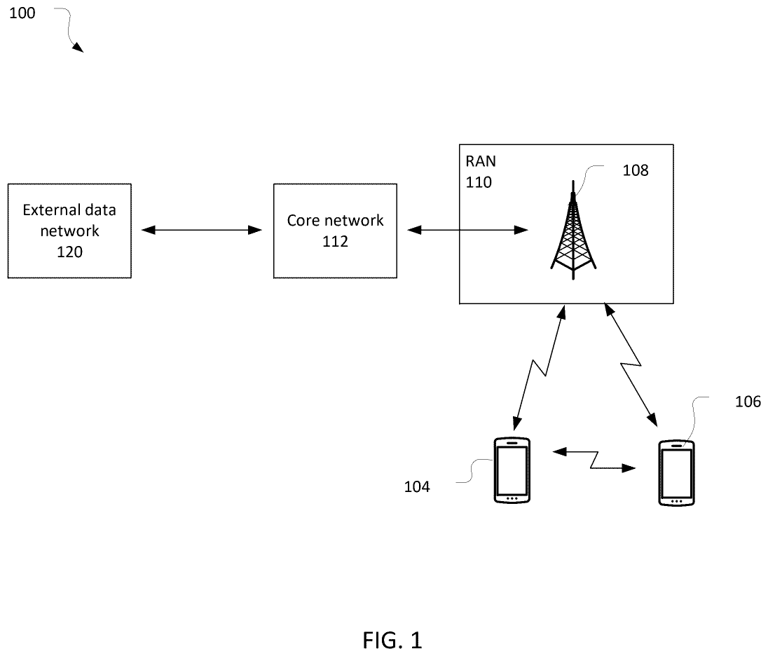

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

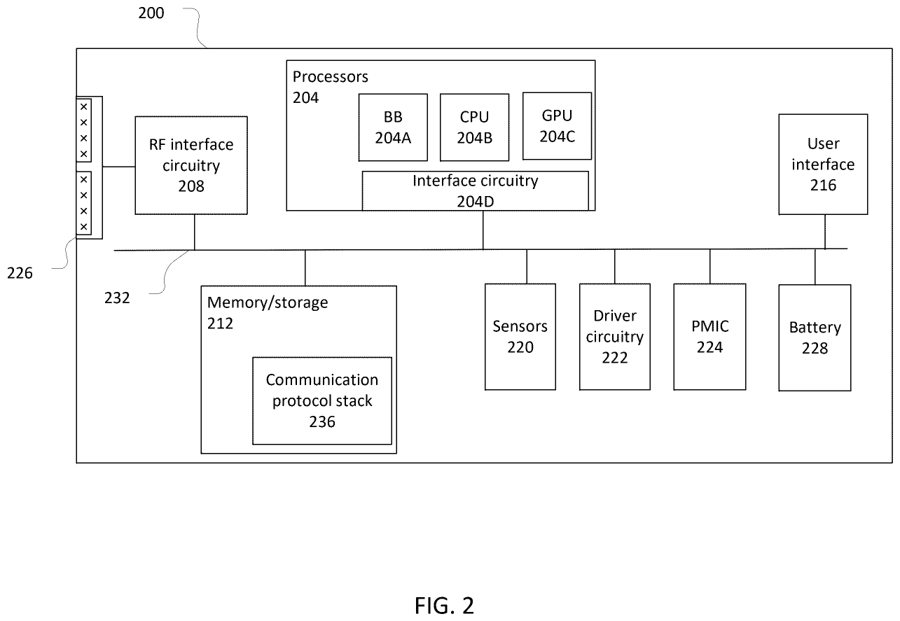

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform quasi-co-location assumption operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

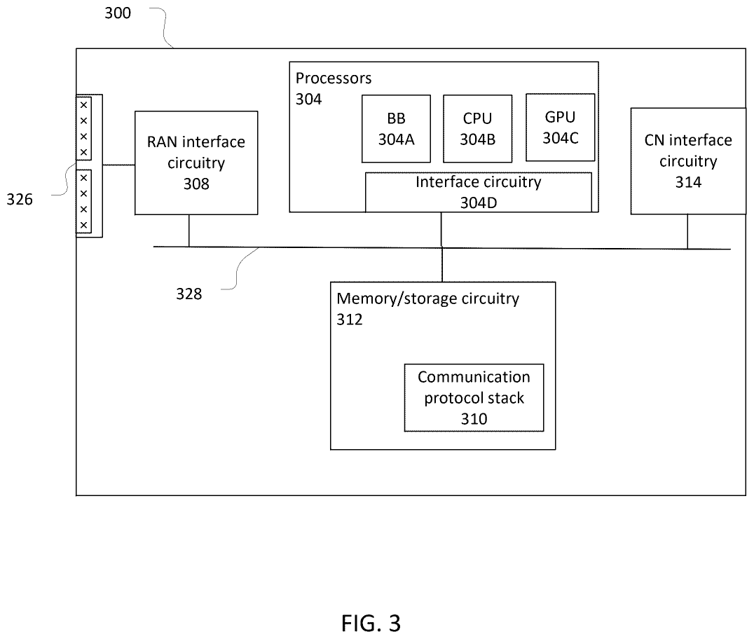

FIG. 3 illustrates a network device 300 in accordance with some embodiments.

The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In fifth generation (5G)/new radio (NR), the concept of quasi-co-location assumptions was specified, which is essentially a relation between two reference signals (source reference signal (RS) and target RS) at the user equipment (UE) receiver for downlink (DL) reception and/or at the UE transmitter for uplink (UL) transmission. Based on this relation, UE can use the similarities like delay spread, Doppler spread, Doppler shift, average delay, spatial filter for beam-based transmission/reception.

Transmission configuration indication (TCI) may be used to signal the quasi-co-location (QCL) assumption that the UE should apply for the transmission and/or reception of the target RS and associated transmissions/receptions. Basically, in NR types of QCLs are specified including: QCL type A: Doppler shift, Doppler spread, average delay, delay spread; QCL type B: Doppler shift, Doppler spread′; QCL type C: Average delay, Doppler shift; and QCL type D: Spatial filter.

However, in NR, for the purpose of beam indication, when QCL type D is signaled to the UE, there is no signaling and distinction between the near-field beams and far-field beams. This is mainly due to the fact that in NR, the underlying assumption for operation is in far-field and there is not support for beam-management operation in near-field.

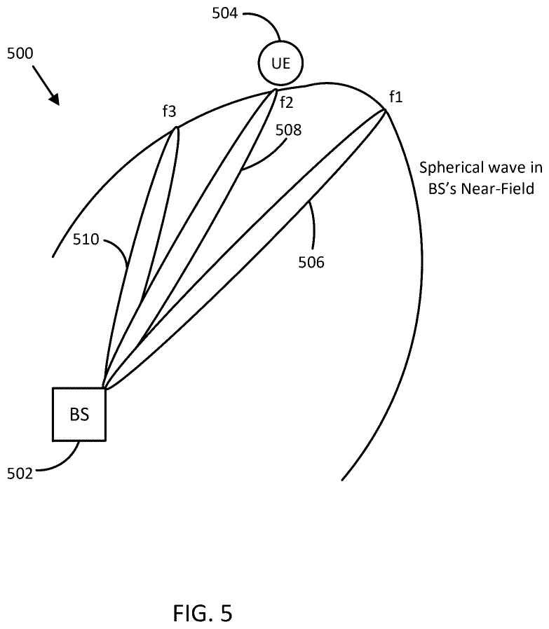

Considering the different characteristics associated with spatial beams in near-field and far-field (due to beam squinting in near-field, as explained in relation to FIGS. 5 through 13), approaches for an enhanced QCL based framework to support spatial filter assumptions considering whether the UE is communicating in the near-field or far-field region is described.

Near-field range determination may be utilized for determining whether near-field operation or far-field operation is to be utilized for a UE. For uniform planar array (UPA), near

$$R = \frac{2 {f}_{c} {D}^{2}}{c} , where D = \sqrt{{L}_{1}^{2} + {L}_{2}^{2}} ,$$

field range can be determined by and L₁=0.8λN and L₂=0.8λM. Further, f_{c} is the carrier frequency and c is speed of light, D is the antenna aperture (diagonal of the array), L₁ is the antenna array vertical dimension and L₂ is the antenna array horizontal dimension, and N is the number of elements in vertical domain and M is the number of elements in horizontal domain.

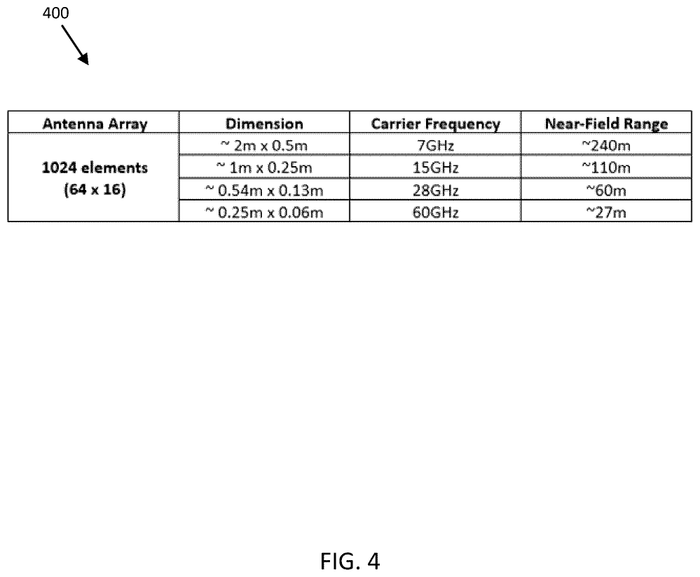

FIG. 4 illustrates a table 400 of example near-field range determinations in accordance with some embodiments. In particular, the table 400 illustrates some example near-field range distances determined in accordance with the equation above for determining near-field range distances.

For new bands such as in frequency range 3 (FR3) (7 gigahertz (GHz)-15 GHz bands) and with enhanced licensed-assisted access (ELAA) in frequency range 2 (FR2), near-field range is expected to be quite long and cannot be ignored. Sixth generation (6G) systems may support operation in both near-field and far-field regions.

A beamforming issue may exist in near-field. For an extremely large array of antennas operating in wide-band, essentially the beamforming gain/directivity splits in multiple directions, depending on the frequency within the wide-band and as a result the expected/desired beamforming gain at intended UE's location is achieved. In near-field region, due to spherical wave, the beamforming gain is not only split at different points/phases, but also at different distance from the Tx/Rx

FIG. 5 illustrates an example beamforming arrangement 500 in accordance with some embodiments. The arrangement 500 illustrates an example of beamforming gain/directivity splits that may occur in near-field.

The arrangement 500 includes a base station 502. The base station 502 may include one or more of the features of the base station 108 (FIG. 1) and/or the network device 300 (FIG. 3). The arrangement 500 further includes a UE 504. The UE 504 may include one or more of the features of the UE 104 (FIG. 1), the UE 106 (FIG. 1), and/or the UE 200 (FIG. 2).

The base station 502 is illustrated transmitting a signal to the UE via beamforming. The base station 502 is transmitting a single beam. However, the single beam may split into different points and different distances on a spherical wave at different frequencies within a wideband. For example, the arrangement 500 shows a first frequency beam split 506, a second frequency beam split 508, and a third frequency beam split 510 of the single beam.

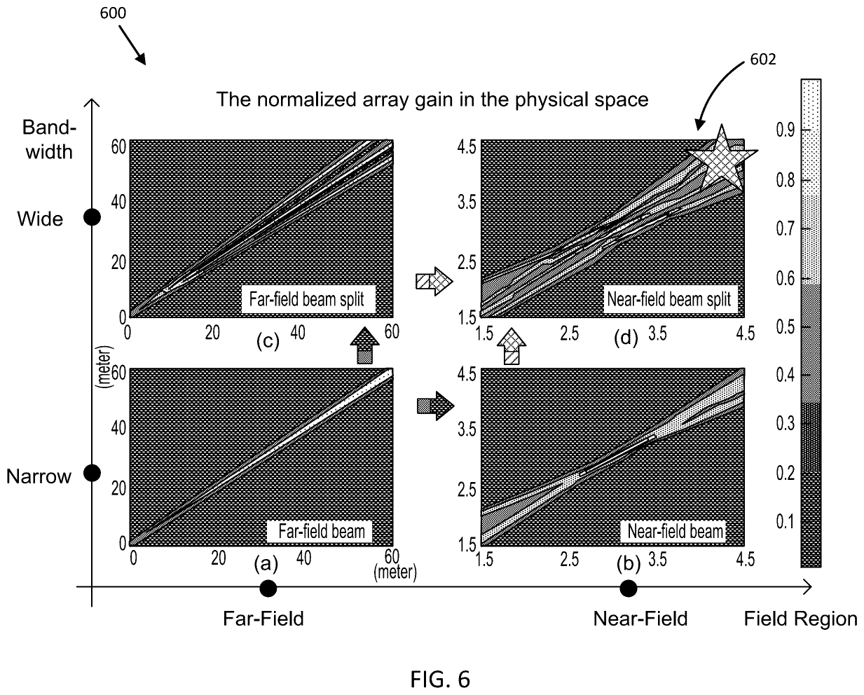

FIG. 6 illustrates representations 600 of example normalized array gains in the physical space in accordance with some embodiments. In particular, the representations 600 include representations for normalized array gain for combinations of narrow and wide bandwidth, and far-field and near-field field regions. As can be seen from representation 602 (the upper right representation), the beam experiences significant beamforming gain splitting at wide band width and near-field, which can be undesirable.

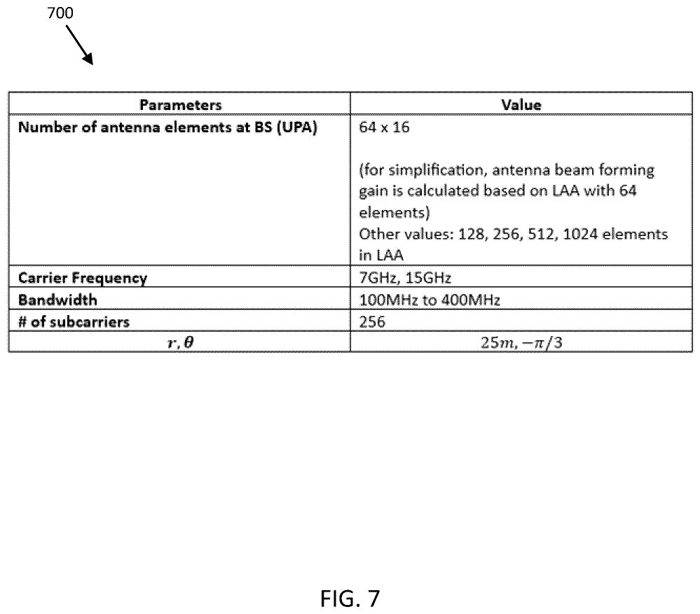

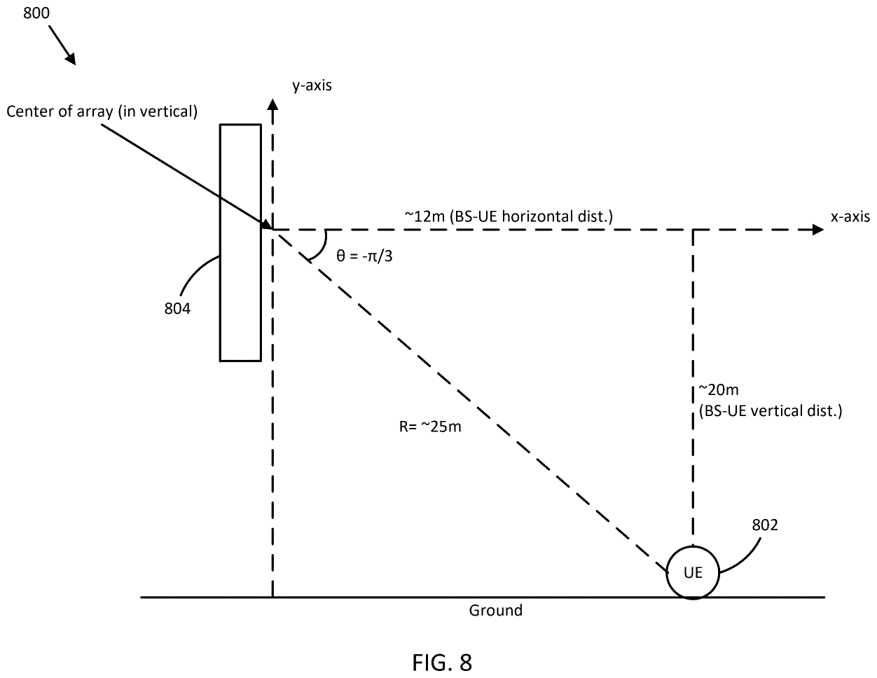

FIG. 7 and FIG. 8 illustrate a simulation scenario/assumption. In particular, FIG. 7 illustrates a table 700 of parameters for an example simulation scenario in accordance with some embodiments. FIG. 8 illustrates an example arrangement 800 for the example simulation scenario in accordance with some embodiments.

The arrangement 800 includes a UE 802. The UE 802 may include one or more of the features of the UE 104 (FIG. 1), the UE 106 (FIG. 1), and/or the UE 200 (FIG. 2). Further, the arrangement 800 includes an antenna array 804 of a base station. The arrangement 800 illustrates positional relationships between the antenna array 804 and the UE 802 for the simulation scenario. The table 700 illustrates values for parameters of the simulation scenario represented by the arrangement 800.

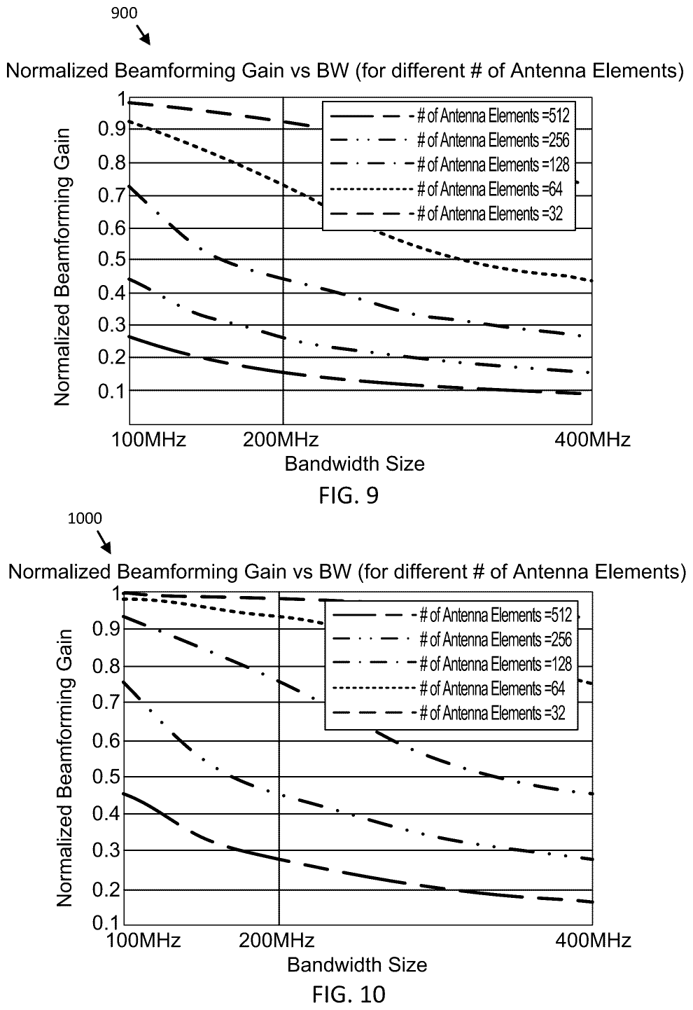

FIG. 9 and FIG. 10 illustrate beamforming representations in near-field. In particular, FIG. 9 illustrates an example normalized beamforming gain representation 900 for carrier frequency of 7 GHz in accordance with some embodiments. FIG. 10 illustrates an example normalized beamforming gain representation 1000 for carrier frequency of 15 GHz in accordance with some embodiments.

As the number of antenna elements increase, the impact of near-field on beamforming can be seen for a UE at a given location. Due to increasing impact of beam squinting with increasing number of antennas (i.e., more prominent near-field impact) there is a significant degradation in beamforming gain.

Alternatively, as a UE is closer and closer to the BS, beamforming gain degradation due to the near-field field impact is more prominent. Basically, for a fixed location, it may be within near-field or far-field region depending on the number of antenna elements. For example, for a number of antenna element 32 with center frequency (CF) of 15 GHZ, there is less than 90% beamforming loss, so it can be assumed that this is in far-field.

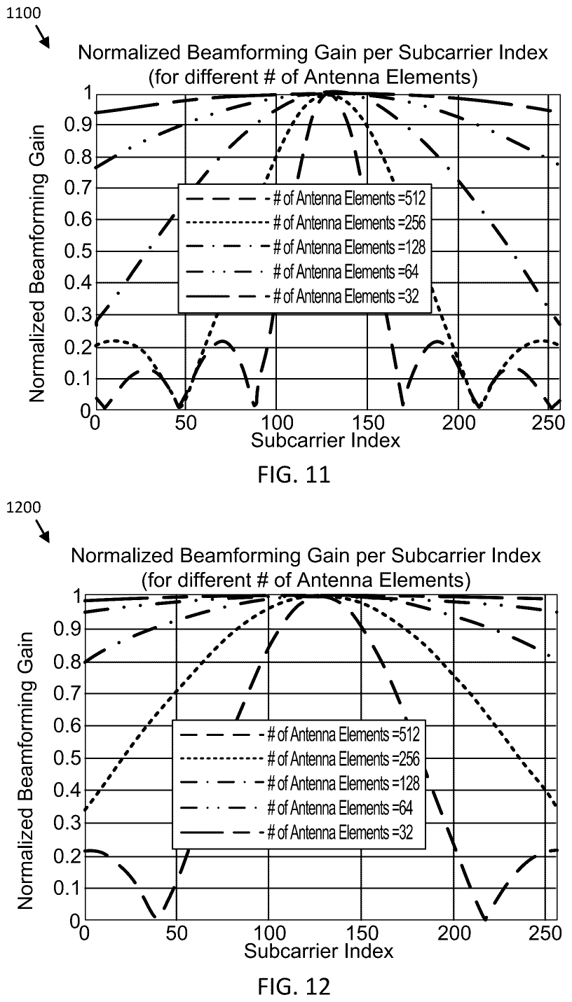

FIG. 11 and FIG. 12 illustrate additional beamforming representations in near-field. In particular, FIG. 11 illustrates an example normalized beamforming gain per subcarrier index representation 1100 for carrier frequency of 7 GHz and bandwidth (BW) size of 100 megahertz (MHz) in accordance with some embodiments. FIG. 12 illustrates an example normalized beamforming gain per subcarrier index representation 1200 for carrier frequency of 15 GHz and BW size of 100 megahertz (MHz) in accordance with some embodiments.

Another measure of the beamforming performance degradation in the near-field compared to far-field is significant degradation on the carriers that are farther away from the central frequency carrier within a band, as analyzed in FIG. 11 and FIG. 12.

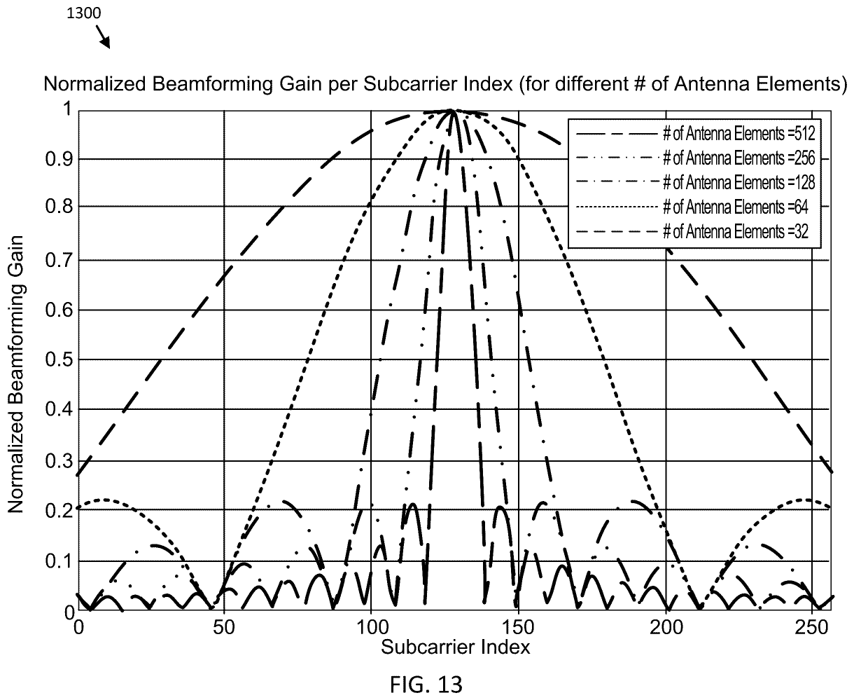

Degradation is even worse in near field when combined with wideband allocation, as analyzed in FIG. 13. For example, FIG. 13 illustrates an example normalized beamforming gain per subcarrier index representation 1300 for carrier frequency of 7 GHz and bandwidth size of 400 MHz in accordance with some embodiments. As can be seen, the degradation shown in the representation 1300 is greater than the degradation of the representation 1100 and the representation 1200 due to the larger bandwidth size.

According to a first approach (which may be referred to as approach 1), a new QCL type may be introduced. In particular, the new QCL type may be in addition to the QCL type A, the QCL type B, QCL type C, and QCL type D previously described. The new QCL type may be referred to as QCL type E. The QCL type E may be signaled to the UE to indicate which field should be assumed by the UE, i.e. either near-field or far-field based on the corresponding source reference signal (RS) for QCL type E and additionally the spatial filter to be applied is based on QCL type D, as in new radio (NR). For example, the QCL type E may indicate that the UE is to apply a spatial filter in consideration of the near-field assumption or the far-field assumption indicated by the QCL type E. Applying the spatial filter may include processing the corresponding reference signal (such as generating the reference signal for transmission and/or processing the received reference signal).

For the first approach, if the source RS (associated with the QCL type E) was transmitted/received by applying near field assumption, then the target RS may also be transmitted/received by applying near field assumption as the source RS. If the source RS (associated with QCL type E) was transmitted/received by applying far field assumption, then the target RS may also be transmitted/received by applying far field assumption as the source RS.

According to one embodiment of the first approach, if QCL type E is supported and/or configured for a UE, then the transmission configuration indicator (TCI) indication to the UE may also indicate QCL type D along with QCL type E

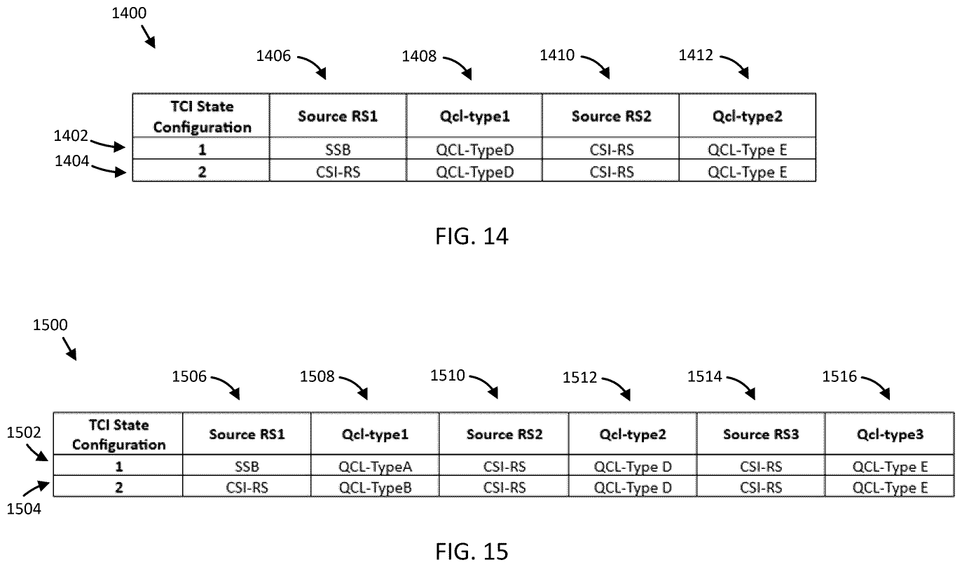

In one example, two RSs with one corresponding to QCL type E and another corresponding to QCL type D may be indicated by TCI state. For example, FIG. 14 illustrates an example table 1400 of TCI information in accordance with some embodiments. The data included in the table 1400 may be included in a configuration message or messages (such as a TCI configuration message) transmitted from a base station to a UE to configure the UE with TCI state configurations.

The table 1400 includes a first TCI state configuration 1402 and a second TCI state configuration 1404. Each TCI state configuration may include a first source RS 1406 and a second source RS 1410. Further, each TCI state configuration may include a first QCL type 1408 corresponding to the first source RS 1406 and a second QCL type 1412 corresponding to the second source RS 1410. As an example, the first TCI state configuration 1402 includes a synchronization signal block (SSB) for the first source RS 1406 and QCL-TypeD for the first QCL type 1408. The first QCL type 1408 being QCL-TypeD may indicate that a spatial filter considering far-field assumption is to be applied to the SSB as the first source RS. Further, the first TCI state configuration 1402 includes a channel state information-reference signal (CSI-RS) for the second source RS 1410 and QCL-Type E for the second QCL type 1412. The second QCL type 1412 being QCL-Type E may indicate that a spatial filter considering near-field assumption is to be applied to the CSI-RS as the second source RS. The same QCL type applied to a source RS may be applied to corresponding target RSs.

In another example, 3 RSs with one corresponding to QCL type E, another corresponding to QCL type D are indicated by TCI state and another one corresponding to either QCL type A or B or C. For example, FIG. 15 illustrates an example table of TCI information in accordance with some embodiments. The data included in the table 1500 may be included in a configuration message or messages (such as a TCI configuration message) transmitted from a base station to a UE to configure the UE with TCI state configurations.

The table 1500 includes a first TCI state configuration 1502 and a second TCI state configuration 1504. Each TCI state configuration may include a first source RS 1506, a second source RS 1510, and a third source RS 1514. Further, each TCI state configuration may include a first QCL type 1508 corresponding to the first source RS 1506, a second QCL type 1512 corresponding to the second source RS 1510, and a third QCL type 1516 corresponding to the third source RS 1514. As an example, the first TCI state configuration 1502 includes an SSB for the first source RS 1506 and QCL-TypeA for the first QCL type 1508. The first QCL type 1508 being QCL-TypeA may indicate that doppler shift, doppler spread, average delay, and delay spread determinations are to be performed for the SSB as the first RS. Further, the first TCI state configuration 1502 includes a CSI-RS for the second source RS 1510 and QCL-Type D for the second QCL type 1512. The second QCL type 1512 being QCL-Type D may indicate that a spatial filter considering far-field assumption is to be applied to the CSI-RS as the second RS. The first TCI state configuration 1502 further includes a CSI-RS for the third source RS 1514 and QCL-Type E for the third QCL type 1516. The third QCL type 1516 being QCL-Type E may indicate that a spatial filter considering near-field assumption is to be applied to the CSI-RS as the third RS. The same QCL type applied to a source RS may be applied to corresponding target RSs.

In a second approach (which may be referred to as approach 2), an enhanced QCL Type D and new QCL Type may be implemented. The new QCL type may be in addition to the QCL type A, the QCL type B, QCL type C, and QCL type D previously described. According to the second approach, a new QCL type is introduced. The new QCL type may be referred to as QCL type E. If the QCL type E is signaled to the UE, then near-field may be applied and if QCL type D is signaled to the UE then far-field may be applied. The spatial filter to be applied may be based on the spatial filter used for the associated source RS. For example, the source RS for QCL type E (if near field is signaled) or the source RS for QCL type D (if far-field is signaled).

According to some first embodiments of the second approach, only QCL type D or QCL type E may be signaled to a UE for a given transmission/reception. For example, the network may tell the UE whether to apply spatial filter considering near-field or spatial filter considering far-field.

According to some other second embodiments of the second approach, both QCL type D and QCL type E can be signaled to UE for a given transmission/reception and it may be up to UE implementation to apply the spatial filter considering near-field or far-field. From network perspective, this may be transparent. In some implementations, the UE may also switch between the two assumptions depending on a first option of scheduled duration, a second option of scheduled number of transmissions, and/or a third option of specific scheduled physical channel.

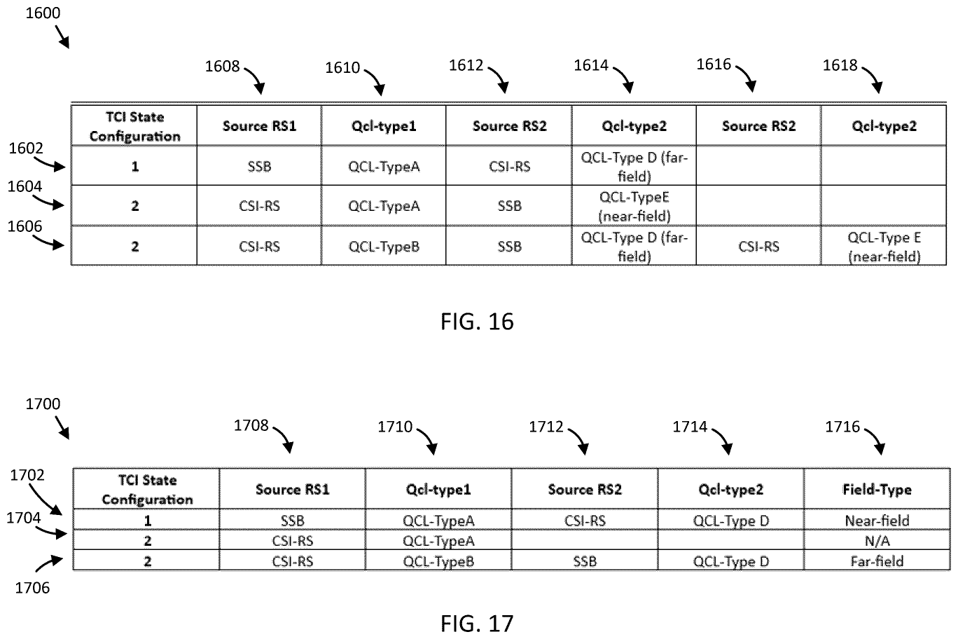

FIG. 16 illustrates an example table 1600 of TCI information in accordance with some embodiments. The data included in the table 1600 may be included in a configuration message or messages (such as a TCI configuration message) transmitted from a base station to a UE to configure the UE with TCI state configurations.

The table 1600 includes a first TCI state configuration 1602, a second TCI state configuration 1604, and a third TCI state configuration 1606. The first TCI state configuration 1602 and the second TCI state configuration 1604 correspond to the first embodiments of the second approach. The third TCI state configuration 1606 corresponds to the second embodiments of the second approach. Each TCI state configuration may include a first source RS 1608, a first option 1612 for a second source RS, and a second option 1616 for the second source RS. Further, each TCI state may include a first QCL type 1610 corresponding to the first source RS 1608, a first option 1614 for a second QCL type corresponding to the second source RS, and a second option 1618 for the second QCL type corresponding to the second source RS.

The first TCI state configuration 1602 includes an SSB for the first source RS 1608 and QCL-TypeA for the first QCL type 1610. The first QCL type 1610 being QCL-TypeA may indicate that doppler shift, doppler spread, average delay, and delay spread are to be determined for the SSB as the first source RS. The first TCI state configuration 1602 includes a first option 1612 for the second source RS, whereas the second option 1616 option for the second source RS is blank. This may indicate that the UE is only configured with one QCL type for the second source RS and applies to the one QCL type. The first TCI state configuration 1602 includes a CSI-RS for the first option 1612 of the second source RS and QCL-Type D for the first option 1614 of the second QCL type. The first option 1614 being QCL-Type D may indicate that a spatial filter considering far-field assumption is to be applied to the CSI-RS for the second source RS for the first TCI state configuration 1602. The same QCL type applied to a source RS may be applied to corresponding target RSs.

The second TCI state configuration 1604 includes a CSI-RS for the first source RS 1608 and QCL-TypeA for the first QCL type 1610. The first QCL type 1610 being QCL-TypeA may indicate that doppler shift, doppler spread, average delay, and delay spread are to be determined for the SSB as the first source RS. The second TCI state configuration 1604 includes a first option 1612 for the second source RS, whereas the second option 1616 option for the second source RS is blank. This may indicate that the UE is only configured with one QCL type for the second source RS and applies to the one QCL type. The second TCI state configuration 1604 includes an SSB for the first option 1612 of the second source RS and QCL-Type E for the first option 1614 of the second QCL type. The first option 1614 being QCL-Type E may indicate that a spatial filter considering near-field assumption is to be applied to the CSI-RS for the second source RS for the second TCI state configuration 1604. The same QCL type applied to a source RS may be applied to corresponding target RSs.

The third TCI state configuration 1606 includes a CSI-RS for the first source RS 1608 and QCL-TypeB for the first QCL type 1610. The first QCL type 1610 being QCL-TypeB may indicate that doppler shift and doppler spread are to be determined for the SSB as the first source RS. The third TCI state configuration 1606 includes a first option 1612 and a second option 1616 for the second source RS. Further, the third TCI state configuration 1606 includes a first option 1614 and a second option 1618 for the second QCL type. This may indicate that the UE can select between the first options and the second options based on the scheduled duration, the scheduled number of transmissions, or specific scheduling physical channel. The third TCI state configuration 1606 includes an SSB for the first option 1612 of the second source RS and QCL-Type D for the first option 1614 of the second QCL type. The third TCI state configuration 1606 includes a CSI-RS for the second option 1616 of the second source RS and QCL-Type E for the second option 1618 of the second QCL type. This may indicate that the UE may select between using SSB and spatial filtering considering far-field assumption, and using CSI-RS and spatial filtering considering near-field assumption. The same QCL type applied to a source RS may be applied to corresponding target RSs.

A third approach (which may be referred to as approach 3) may implement an enhanced TCI configuration option 1. According to the third approach, the TCI configuration may be enhanced to indicate whether the corresponding QCL types are applied for near-field or far-field. Similar QCL types as in NR may be configured for a TCI index, but additionally, it may signal the near-field or far-field assumption.

Two options are considered for the third approach. For a first option (which may be referred to as option 1), a TCI configuration may include additional indication of near-field or far-field only if QCL type D is configured for a given TCI index. In a second option (which may be referred to as option 2), the default assumption may be far-field if the TCI configuration does not explicitly signal near-field or far-field assumption.

FIG. 17 illustrates an example table 1700 of TCI information in accordance with some embodiments. The data included in the table 1700 may be included in a configuration message or messages (such as a TCI configuration message) transmitted from a base station to a UE to configure the UE with TCI state configurations.

The table 1700 includes a first TCI state configuration 1702, a second TCI state configuration 1704, and a third TCI state configuration 1706. The first TCI state configuration 1702 and the second TCI state configuration 1704 may correspond to the first option for the third approach. The third TCI state configuration 1706 may correspond to the second option for the third approach. Each TCI state configuration may include a first source RS 1708 and a second source RS 1712. Further, each TCI state configuration may include a first QCL type 1710 corresponding to the first source RS 1708 and a second QCL type 1714 corresponding to the second source RS 1712. Each TCI state configuration may further include a field type 1716 that indicates a field assumption.

The first TCI state configuration 1702 includes an SSB for the first source RS 1708 and QCL-TypeA for the first QCL type 1710. The first QCL type 1710 being QCL-TypeA may indicate that doppler shift, doppler spread, average delay, and delay spread are to be determined for the SSB as the first source RS. The first TCI state configuration 1702 includes a CSI-RS for the second source RS, QCL-Type D for the second QCL type 1714, and near-field for the field type 1716. The second QCL type 1714 being QCL-Type D and the field type 1716 being near-field may indicate that a spatial filter considering near-field assumption is to be applied to the CSI-RS for the second source RS. The same QCL type applied to a source RS may be applied to corresponding target RSs.

The second TCI state configuration 1704 includes a CSI-RS for the first source RS 1708 and QCL-TypeA for the first QCL type 1710. The first QCL type 1710 being QCL-TypeA may indicate that doppler shift, doppler spread, average delay, and delay spread are to be determined for the CSI-RS as the first source RS. The second TCI state configuration 1704 does not include a second source RS 1712 and a second QCL type 1714. For the first option of the third approach, since none of the QCL types of the second TCI state configuration 1704 are assigned QCL-Type D, the field type 1716 may be left unassigned (e.g., blank) as well. For the second option of the third approach, the UE may apply the far-field assumption based on no value being supplied for the field type 1716.

The third TCI state configuration 1706 includes a CSI-RS for the first source RS 1708 and QCL-TypeB for the first QCL type 1710. The first QCL type 1710 being QCL-TypeB may indicate that doppler shift and doppler spread are to be determined for the CSI-RS for the first source RS. The third TCI state configuration 1706 includes an SSB for the second source RS 1712, QCL-Type D for the second QCL type 1714, and far-field for the field type 1716. The second QCL type 1714 being QCL-Type D and the field type 1716 being far-field may indicate that a spatial filter considering far-field assumption is to be applied to the SSB for the second source RS. The same QCL type applied to a source RS may be applied to corresponding target RSs.

A fourth approach (which may be referred to as approach 4) may implement an enhanced TCI configuration option 2. According to the fourth approach, a TCI configuration may be enhanced to indicate multiple QCL type D source RSs. If multiple QCL type D source RSs are indicated, then the UE can assume that it is to apply multiple spatial filters across the bandwidth allocation and the number of sub-bands are based on number of spatial filters indicated by TCI index (i.e. number of QCL type Ds). Each spatial filter may be applied in a sequential order from lower sub-band to higher sub-band within the allocated bandwidth.

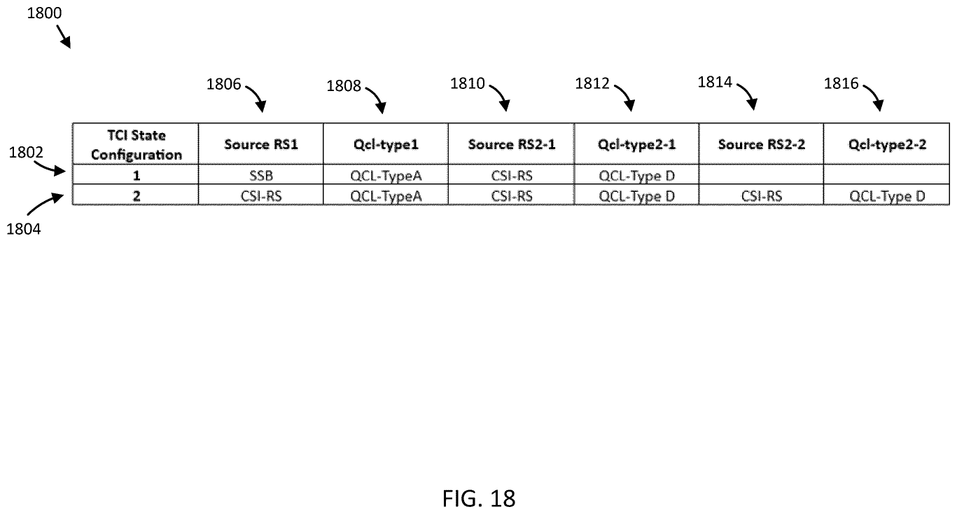

FIG. 18 illustrates an example table 1800 of TCI information in accordance with some embodiments. The data included in the table 1800 may be included in a configuration message or messages (such as a TCI configuration message) transmitted from a base station to a UE to configure the UE with TCI state configurations.

The table 1800 includes a first TCI state configuration 1802 and a second TCI state configuration 1804. Each TCI state configuration may include a first source RS 1806, a first option 1810 of a second source RS, and a second option 1814 of the second source RS. Further, each TCI state configuration may include a first QCL type 1808 corresponding to the first source RS 1806, a first option 1812 for the second QCL type corresponding to the first option 1810 of the second source RS, and a second option 1816 corresponding to the second option 1814 of the second source RS.

The second TCI state configuration 1804 illustrates an example of approach 4. The second TCI state configuration 1804 includes a CSI-RS for the first source RS 1806 and QCL-TypeA for the first QCL type 1710. The first QCL type 1808 being QCL-TypeA may indicate that doppler shift, doppler spread, average delay, and delay spread are to be determined for the CSI-RS as the first source RS. The second TCI state configuration 1804 includes a CSI-RS for the first option 1810 of the second source RS and QCL-Type D for the first option 1812 of the second QCL type. Further, the second TCI state configuration 1804 includes a CSI-RS for the second option 1814 of the second source RS and QCL-Type D for the second option 1816 of the second QCL type. The second TCI state configuration 1804 having the first option 1812 and the second option 1816 of QCL type both assigned with QCL-TypeD may indicate that the UE is to apply multiple spatial filters across the bandwidth allocation and the number of sub-bands based on the number of spatial filters indicated by the TCI index. The spatial filters may be applied in sequential order, with the spatial filter corresponding to the first option 1812 being for a lower sub-band and the second option 1816 being for the higher sub-band.

A fifth approach (which may be referred to as approach 5) may implement an enhanced TCI Configuration option 3. According to the fifth approach, a TCI index activated for a UE and/or indicated via downlink control information (DCI) may indicate multiple TCI states with QCL type D assumption in case of near-field. Each of the indicated TCI state for a given index may be applied for the corresponding sub-band within the allocated bandwidth.

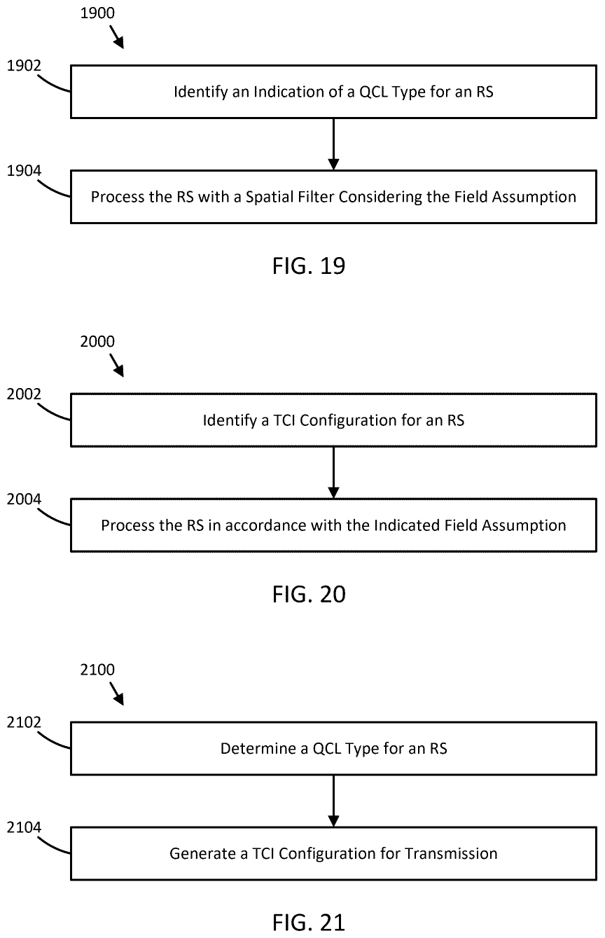

FIG. 19 illustrates an example procedure 1900 for processing an RS with a spatial filter in accordance with some embodiments. The procedure 1900 may be performed by a UE, such as the UE 104 (FIG. 1), the UE 106 (FIG. 1), and/or the UE 200 (FIG. 2).

The procedure 1900 may include identifying an indication of a quasi-co-location (QCL) type for a reference signal (RS) in 1902. The QCL type may indicate a field assumption of beamforming for the RS. In some embodiments, the field assumption may comprise a near-field assumption or a far-field assumption.

The procedure 1900 may include processing the RS with a spatial filter considering the field assumption in 1904.

In some embodiments, the RS may be a source RS. In some of these embodiments, the procedure 1900 may further include processing a target RS with the spatial filter considering the field assumption.

In some embodiments, the indication of the QCL type is included in a transmission configuration indicator (TCI) indication. Further, the QCL type may be a first QCL type and the RS may be a first RS in some of these embodiments. In some of these embodiments, the TCI indication may further include an indication of a second QCL type for a second RS.

In some embodiments, the field assumption is a near-field assumption of beamforming. Further, processing the RS in accordance with the field assumption may comprise processing the RS with a spatial filter considering the near-field assumption.

In some embodiments, the QCL type may be a first QCL type, and the field assumption may be a first field assumption. In these embodiments, the procedure 1900 may further include identifying an indication of a second QCL type for the RS, the second QCL type indicating a second field assumption of beamforming for the RS. Further, the procedure 1900 may include determining whether to process the RS considering the first field assumption or the second field assumption based at least in part on a scheduled duration, a scheduled number of transmissions, or a specific scheduled physical channel. Processing the RS with the spatial filter may comprise processing the RS with a first spatial filter considering the first field assumption or processing the RS with a second spatial filter considering the second field assumption based at least in part on the determination.

Any one or more of the operations in FIG. 19 may be performed in a different order than shown and/or one or more of the operations may be performed concurrently in embodiments. Further, it should be understood that one or more of the operations may be omitted from and/or one or more additional operations may be added to the procedure 1900 in other embodiments.

FIG. 20 illustrates an example procedure 2000 for processing an RS in accordance with an indicated field assumption in accordance with some embodiments. The procedure 2000 may be performed by a UE, such as the UE 104 (FIG. 1), the UE 106 (FIG. 1), and/or the UE 200 (FIG. 2).

The procedure 2000 may include identifying a transmission configuration indicator (TCI) configuration for a reference signal (RS) in 2002. The TCI configuration indicating a field assumption for the RS.

The procedure 2000 may include processing the RS in accordance with the indicated field assumption in 2004.

In some embodiments, the TCI configuration may indicate a TCI index corresponding to the RS, and the TCI configuration may include an indication of the field assumption. In some of these embodiments, the procedure 2000 may further include determining to process the RS in accordance with the field assumption based at least in part on the TCI index corresponding to the RS being configured with a quasi-co-location (QCL) type D.

In some embodiments, the procedure 2000 may further include determining whether the TCI configuration includes an explicit indication of a near-field assumption or a far-field assumption. Further, the procedure 2000 may include determining the field assumption based at least in part on the determination whether the TCI configuring includes the explicit indication. In some of these embodiments, determining the field assumption may comprise determining the field assumption to be the near-field assumption based at least in part on determining that the TCI configuration includes the explicit indication of the near-field assumption, determining the field assumption to be the far-field assumption based at least in part on determining that the TCI configuration includes the explicit indication of the far-field assumption, or determining the field assumption to be the far-field assumption based at least in part on determining that the TCI configuration does not include the explicit indication.

In some embodiments, the TCI configuration may indicate multiple RSs associated with quasi-co-location (QCL) type D, where the multiple RSs may include the RS. The procedure 2000 may further include applying multiple spatial filters, for processing the multiple RSs, across a bandwidth allocation and a number of sub-bands based at least in part on a number of spatial filters indicated by a TCI index within the TCI configuration. In some of these embodiments, the multiple spatial filters may be applied in a sequential order from a lower sub-band to a higher sub-band within the bandwidth allocation.

In some embodiments, the procedure 2000 may include determining a TCI index activated or indicated via downlink control information (DCI), the TCI index indicating multiple TCI states with quasi-co-location (QCL) type D for near-field assumption. Further, the procedure 2000 may include applying one or more TCI states, of the multiple TCI states, for a given TCI index for a corresponding sub-band within an allocated bandwidth.

Any one or more of the operations in FIG. 20 may be performed in a different order than shown and/or one or more of the operations may be performed concurrently in embodiments. Further, it should be understood that one or more of the operations may be omitted from and/or one or more additional operations may be added to the procedure 2000 in other embodiments.

FIG. 21 illustrates an example procedure 2100 for generating a TCI configuration in accordance with some embodiments. The procedure 2100 may be performed by a base station, such as the base station 108 (FIG. 1), and/or the network device 300 (FIG. 3).

The procedure 2100 may include determining a quasi-co-location (QCL) type for a reference signal (RS) in 2102. The QCL type may indicate a field assumption for the RS. In some embodiments, the field assumption indicated by the QCL type may comprise a near-field assumption.

The procedure 2100 may include generating a transmission configuration indicator (TCI) configuration for transmission in 2104. The TCI configuration may include an indication of the QCL type for the RS.

In some embodiments, the RS may be a first RS, and the QCL type may be a first QCL type. The TCI configuration may include an indication of a TCI state that includes the first RS with the first QCL type and a second RS with a second QCL type in some embodiments. In some of these embodiments, the indication of the TCI state may further include a third RS with a third QCL type.

In some embodiments, the TCI configuration may further include an indication of near-field assumption or far-field assumption for the QCL type.

In some embodiments, the TCI configuration may indicate multiple RSs associated with QCL type D. The multiple RSs may include the RS. Indicating the multiples RSs may indicate that multiple spatial filters are to be applied across a bandwidth allocation and a number of sub-bands.

Any one or more of the operations in FIG. 21 may be performed in a different order than shown and/or one or more of the operations may be performed concurrently in embodiments. Further, it should be understood that one or more of the operations may be omitted from and/or one or more additional operations may be added to the procedure 2100 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying an indication of a quasi-co-location (QCL) type for a reference signal (RS), the QCL type indicating a field assumption of beamforming for the RS, and processing the RS with a spatial filter considering the field assumption.

Example 2 may include the method of example 1, wherein the field assumption comprises a near-field assumption or a far-field assumption.

Example 3 may include the method of example 1, wherein the RS is a source RS, and wherein the method further comprises processing a target RS with the spatial filter considering the field assumption.

Example 4 may include the method of example 1, wherein the indication of the QCL type is included in a transmission configuration indicator (TCI) indication.

Example 5 may include the method of example 4, wherein the QCL type is a first QCL type, wherein the RS is a first RS, and wherein the TCI indication further includes an indication of a second QCL type for a second RS.

Example 6 may include the method of example 1, wherein the field assumption is a near-field assumption of beamforming, and wherein processing the RS in accordance with the field assumption comprises processing the RS with a spatial filter considering the near-field assumption.

Example 7 may include the method of example 1, wherein the QCL type is a first QCL type, wherein the field assumption is a first field assumption, and wherein the method further comprises identifying an indication of a second QCL type for the RS, the second QCL type indicating a second field assumption of beamforming for the RS, and determining whether to process the RS considering the first field assumption or the second field assumption based at least in part on a scheduled duration, a scheduled number of transmissions, or a specific scheduled physical channel, wherein processing the RS with the spatial filter comprises processing the RS with a first spatial filter considering the first field assumption or processing the RS with a second spatial filter considering the second field assumption based at least in part on the determination.

Example 8 may include a method comprising identifying a transmission configuration indicator (TCI) configuration for a reference signal (RS), the TCI configuration indicating a field assumption for the RS, and processing the RS in accordance with the indicated field assumption.

Example 9 may include the method of example 8, wherein the TCI configuration indicates a TCI index corresponding to the RS, wherein the TCI configuration includes an indication of the field assumption, and wherein the method further comprises determining to process the RS in accordance with the field assumption based at least in part on the TCI index corresponding to the RS being configured with a quasi-co-location (QCL) type D.

Example 10 may include the method of example 8, further comprising determining whether the TCI configuration includes an explicit indication of a near-field assumption or a far-field assumption, and determining the field assumption based at least in part on the determination whether the TCI configuring includes the explicit indication.

Example 11 may include the method of example 10, wherein determining the field assumption comprises determining the field assumption to be the near-field assumption based at least in part on determining that the TCI configuration includes the explicit indication of the near-field assumption, determining the field assumption to be the far-field assumption based at least in part on determining that the TCI configuration includes the explicit indication of the far-field assumption, or determining the field assumption to be the far-field assumption based at least in part on determining that the TCI configuration does not include the explicit indication.

Example 12 may include the method of example 8, wherein the TCI configuration indicates multiple RSs associated with quasi-co-location (QCL) type D, the multiple RSs including the RS, and wherein the method further comprises applying multiple spatial filters, for processing the multiple RSs, across a bandwidth allocation and a number of sub-bands based at least in part on a number of spatial filters indicated by a TCI index within the TCI configuration.

Example 13 may include the method of example 12, wherein the multiple spatial filters are applied in a sequential order from a lower sub-band to a higher sub-band within the bandwidth allocation.

Example 14 may include the method of example 8, further comprising determining a TCI index activated or indicated via downlink control information (DCI), the TCI index indicating multiple TCI states with quasi-co-location (QCL) type D for near-field assumption, and applying one or more TCI states, of the multiple TCI states, for a given TCI index for a corresponding sub-band within an allocated bandwidth.

Example 15 may include a method comprising determining a quasi-co-location (QCL) type for a reference signal (RS), the QCL type indicating a field assumption for the RS, and generating a transmission configuration indicator (TCI) configuration for transmission, the TCI configuration including an indication of the QCL type for the RS.

Example 16 may include the method of example 15, wherein the RS is a first RS, wherein the QCL type is a first QCL type, wherein the TCI configuration includes an indication of a TCI state that includes the first RS with the first QCL type and a second RS with a second QCL type.

Example 17 may include the method of example 16, wherein the indication of the TCI state further includes a third RS with a third QCL type.

Example 18 may include the method of example 15, wherein the field assumption indicated by the QCL type comprises a near-field assumption.

Example 19 may include the method of example 15, wherein the TCI configuration further includes an indication of near-field assumption or far-field assumption for the QCL type.

Example 20 may include the method of example 15, wherein the TCI configuration indicates multiple RSs associated with QCL type D, the multiple RSs including the RS, wherein indicating the multiples RSs indicates that multiple spatial filters are to be applied across a bandwidth allocation and a number of sub-bands.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying an indication of a quasi-co-location (QCL) type for a reference signal (RS), the QCL type indicating a field assumption of beamforming for the RS; and
processing the RS with a spatial filter considering the field assumption.

2. The method of claim 1, wherein the field assumption comprises a near-field assumption or a far-field assumption.

3. The method of claim 1, wherein the RS is a source RS, and wherein the method further comprises:
processing a target RS with the spatial filter considering the field assumption.

4. The method of claim 1, wherein the indication of the QCL type is included in a transmission configuration indicator (TCI) indication.

5. The method of claim 4, wherein the QCL type is a first QCL type, wherein the RS is a first RS, and wherein the TCI indication further includes:
an indication of a second QCL type for a second RS.

6. The method of claim 1, wherein the field assumption is a near-field assumption of beamforming, and wherein processing the RS in accordance with the field assumption comprises processing the RS with a spatial filter considering the near-field assumption.

7. The method of claim 1, wherein the QCL type is a first QCL type, wherein the field assumption is a first field assumption, and wherein the method further comprises:
identifying an indication of a second QCL type for the RS, the second QCL type indicating a second field assumption of beamforming for the RS; and
determining whether to process the RS considering the first field assumption or the second field assumption based at least in part on a scheduled duration, a scheduled number of transmissions, or a specific scheduled physical channel, wherein processing the RS with the spatial filter comprises processing the RS with a first spatial filter considering the first field assumption or processing the RS with a second spatial filter considering the second field assumption based at least in part on the determination.

8. An apparatus comprising:
processing circuitry to:
identify a transmission configuration indicator (TCI) configuration for a reference signal (RS), the TCI configuration indicating a field assumption for the RS; and
process the RS in accordance with the indicated field assumption; and
interface circuitry coupled with the processing circuitry, the interface circuitry to enable communication.

9. The apparatus of claim 8, wherein the TCI configuration indicates a TCI index corresponding to the RS, wherein the TCI configuration includes an indication of the field assumption, and wherein the processing circuitry is further to:
determine to process the RS in accordance with the field assumption based at least in part on the TCI index corresponding to the RS being configured with a quasi-co-location (QCL) type D.

10. The apparatus of claim 8, wherein the processing circuitry is further to:
determine whether the TCI configuration includes an explicit indication of a near-field assumption or a far-field assumption; and
determine the field assumption based at least in part on the determination whether the TCI configuration includes the explicit indication.

11. The apparatus of claim 10, wherein to determine the field assumption comprises to:
determine the field assumption to be the near-field assumption based at least in part on determining that the TCI configuration includes the explicit indication of the near-field assumption;
determine the field assumption to be the far-field assumption based at least in part on determining that the TCI configuration includes the explicit indication of the far-field assumption; or
determine the field assumption to be the far-field assumption based at least in part on determining that the TCI configuration does not include the explicit indication.

12. The apparatus of claim 8, wherein the TCI configuration indicates multiple RSs associated with quasi-co-location (QCL) type D, the multiple RSs including the RS, and wherein the processing circuitry is further to:
apply multiple spatial filters, for processing the multiple RSs, across a bandwidth allocation and a number of sub-bands based at least in part on a number of spatial filters indicated by a TCI index within the TCI configuration.

13. The apparatus of claim 12, wherein the multiple spatial filters are applied in a sequential order from a lower sub-band to a higher sub-band within the bandwidth allocation.

14. The apparatus of claim 8, wherein the processing circuitry is further to:
determine a TCI index activated or indicated via downlink control information (DCI), the TCI index indicating multiple TCI states with quasi-co-location (QCL) type D for near-field assumption; and
apply one or more TCI states, of the multiple TCI states, for a given TCI index for a corresponding sub-band within an allocated bandwidth.

15. A method comprising:
determining a quasi-co-location (QCL) type for a reference signal (RS), the QCL type indicating a field assumption for the RS; and
generating a transmission configuration indicator (TCI) configuration for transmission, the TCI configuration including an indication of the QCL type for the RS.

16. The method of claim 15, wherein the RS is a first RS, wherein the QCL type is a first QCL type, wherein the TCI configuration includes:
an indication of a TCI state that includes the first RS with the first QCL type and a second RS with a second QCL type.

17. The method of claim 16, wherein the indication of the TCI state further includes a third RS with a third QCL type.

18. The method of claim 15, wherein the field assumption indicated by the QCL type comprises a near-field assumption.

19. The method of claim 15, wherein the TCI configuration further includes an indication of near-field assumption or far-field assumption for the QCL type.

20. The method of claim 15, wherein the TCI configuration indicates multiple RSs associated with QCL type D, the multiple RSs including the RS, wherein indicating the multiples RSs indicates that multiple spatial filters are to be applied across a bandwidth allocation and a number of sub-bands.
